(19) United States
(12) Patent Application Publication
(10) Pub. No.: US 2007/0273639 A1
(43) Pub. Date: Nov. 29, 2007

(54) TRACK TYPE IMPACT BUFFERED INPUT DEVICE

(75) Inventors: Chun-Ching Peng, Chung Ho City (TW); Chiu-Tai Chang, Chung Ho City (TW)

Correspondence Address: PAI PATENT & TRADEMARK LAW FIRM, 1001 FOURTH AVENUE, SUITE 3200, SEATTLE, WA, 98154, US

(73) Assignee: CHIC TECHNOLOGY CORP., Chung Ho City (TW)

(21) Appl. No.: 11/420,776

(22) Filed: May 29, 2006

(51) Int. Cl. G09G 5/00

(52) U.S. Cl. 345/156

(57) ABSTRACT

A track type impact buffered input device is equipped with an extra weight buffer. When the input device is moved from a position to another by the user, the weight buffer will retard the motion of the input device with its increased inertia as if a reversed force were applied to the input device. Hence, the impact force imposed on the user's wrist is alleviated by the retarding effect of the weight buffer, and the user does not need to exert a large force to stop the input device at the new position or when a sudden change of moving direction is required, thereby preventing potential injury to the user's wrist by the impact force.

### BACKGROUND OF THE INVENTION

1. Field of the Invention

The present invention relates to a track type impact buffered input device, and more particularly to an input device equipped with a weight increased buffer so as to release the burden to the user's wrist when operating the input device.

2. Description of the Prior Art

Following the progress in high technology, the motion of an input device has changed from the rolling bead mechanism to the modern physical optics type which not only eliminated the troublesome cleaning problem necessary for the conventional rolling bead mechanism from time to time, but also decreased the weight of the input device. The physical optics type input device is really compact in size and with convenient portability. But is it really advantageous to lighten the input device only? A lot of users feel that a light input device is not easy to maintain a stable moving operation. Though, its unstable state is not as significant as a vehicle jouncing when moving in a high speed, it is still problematic. The easiest remedy is to directly add a weight to the input device.

However, though a heavier input device can palliate the shortcoming of instability which a light input device has, it brings about a new problem of aggravating the burden to the user's wrist by repeatedly twisting the wrist in order to bring the input device to a desired position.

From the viewpoint of applied mechanics, the user has to apply varying forces in order to move the input device with different speeds and acceleration to a final desired position, and then might have to abruptly move the input device in another desired different position. This causes a change of momentum of inertia which results in a large impact to the user's wrist.

Such a continuous impact force imposed on the user's wrist may cause an accumulated fatigue, and in the worst case, a physical injury, to the user's wrist.

It is for this reason that the inventor of the present invention has endeavored with great efforts for years trying to palliate the defects noticeable on the conventional input device, and finally come up with a novel track type impact buffered input device as provided in this invention.

### SUMMARY OF THE INVENTION

The object of the present invention is to provide a track type impact buffered input device in which a weight buffer is equipped to alleviate the inertia force of the input device when turning around in different directions so as to prevent injury to the user's wrist from an impact force exerted at that moment.

The inventor of the present invention is aware that the aforesaid impact force will be greater as the weight of the input device is increased, and the required force to halt the input device moving with a fast speed and acceleration, or even to abruptly change its moving direction is very large. Accordingly in the present invention an extra eight buffer is added to retard the motion of the input device and alleviate the impact force imposed on the user's wrist by the inertia force of the input device at the instance when it stops or abruptly changes the moving direction.

### BRIEF DESCRIPTION OF THE DRAWINGS

The above object and other advantages of the present invention will become more apparent from the following detailed description of the preferred embodiments of the present invention with reference to the attached drawings:

FIG. 1 is a perspective view of the present invention; and

FIG. 2 to FIG. 8 show the perspective views of the present invention from a first to a seventh embodiment respectively.

### DETAILED DESCRIPTION OF THE PREFERRED EMBODIMENT

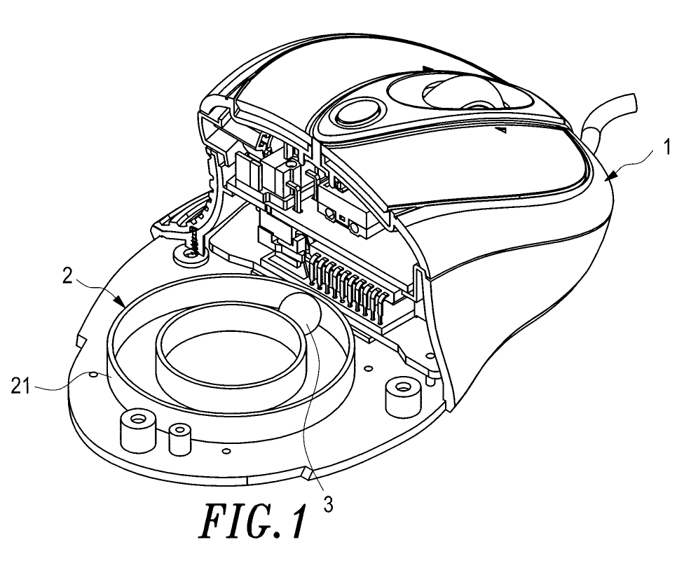

Referring to FIG. 1, the track type impact buffered input device of the present invention comprises one or more than one slide track 2 in a main body 1 of the input device. Each of the slide track 2 is provided with a weight buffer 3, and each slide track 2 is formed into a closed loop type track 21 in various figures such as rectangle, ellipse, or polygon, whereas the weight buffer 3 is made of a massive substance such as a weight, a lead bead, or a gravity ball.

When the main body 1 of the input device is moved from its initial position to a desired position by the user exerting a force, the weight buffer 3 will retard the motion of the main body 1 of the input device with its increased inertia as if a reversed force were applied to the main body 1. In this manner, the impact force imposed on the user's wrist is alleviated by the retarding effect of the weight buffer 3, and the user does not need to exert a large force to stop the main body 1 at a predetermined position or when a sudden change of moving direction is required, thereby preventing injury to the user's wrist by the impact force.

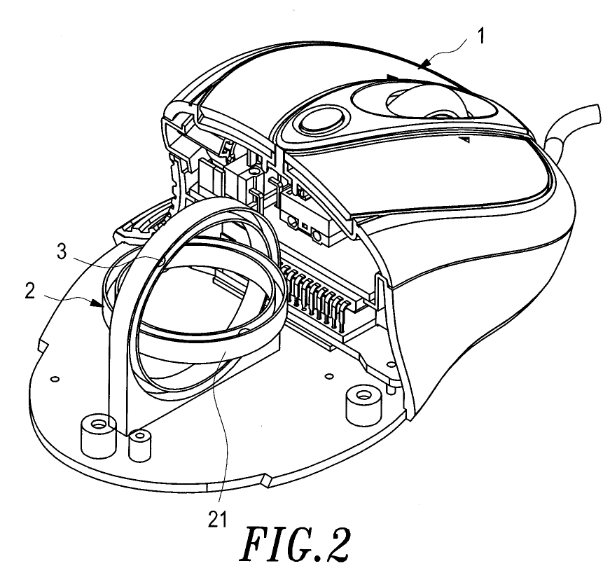

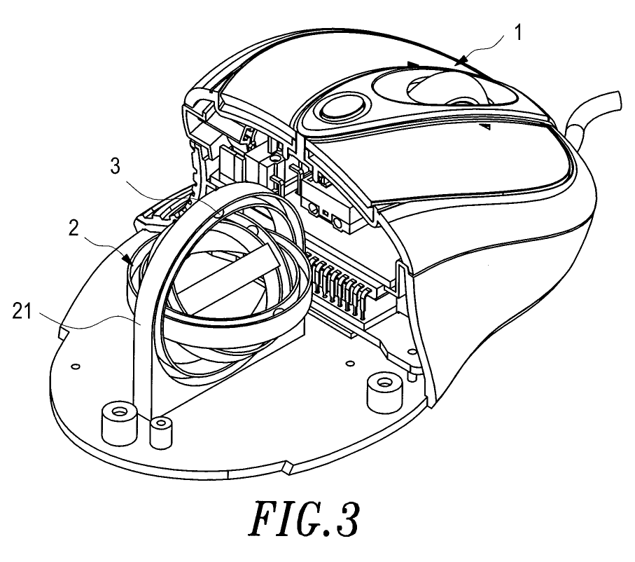

Referring to FIG. 2 and FIG. 3, in the first and the second embodiments of the present invention, the slide tracks 2 in the main body 1 of the input device are disposed in a way such that their longitudinal axes along the advancing direction of the input device are in parallel, perpendicular, or even intersected at an arbitrary angle with each other so as to allow the main body 1 of the input device to move freely in any desired direction.

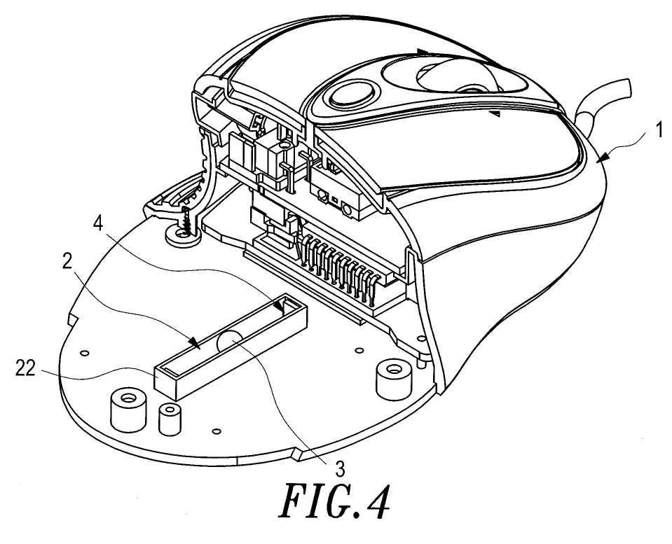

In the third embodiment shown in FIG. 4, the slide track 2 is configured into a long elongated track 21 wherein an elastic buffer 4 is provided at each of the two ends of the slide track 2. The elastic buffer 4 is made of rubber, cotton, foam cotton, thermoplastic elastomer, or spring 41.

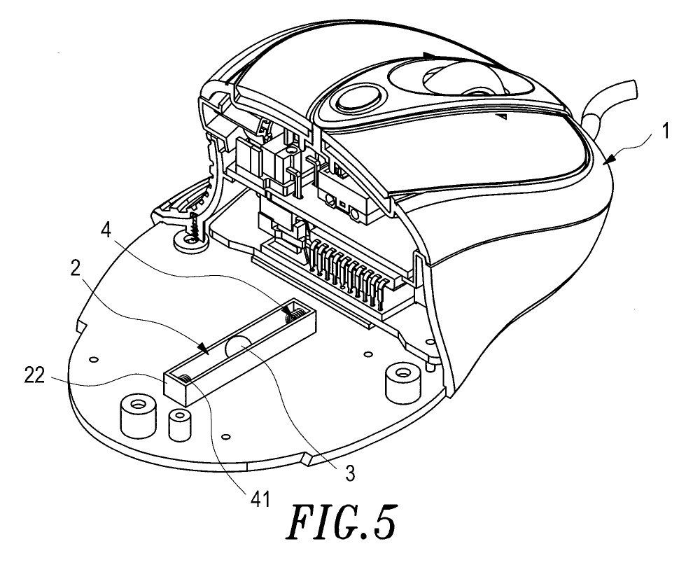

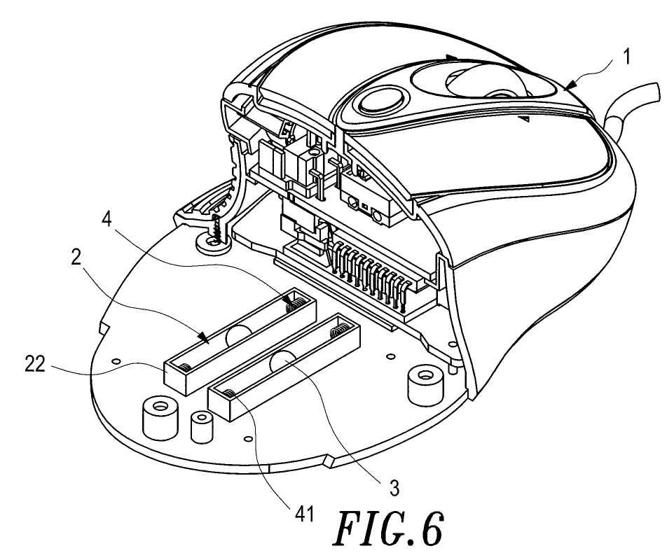

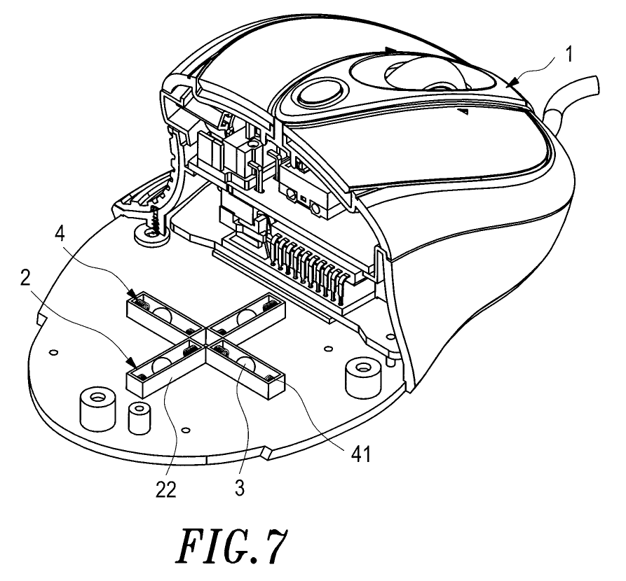

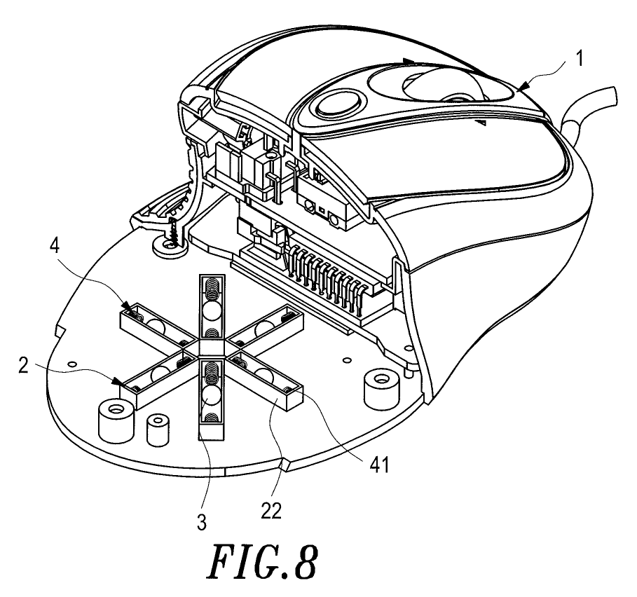

In the rest of the embodiments shown in FIG. 4 through FIG. 8, when the main body 1 of the input device is to be moved from its initial position to a desired position, a force is exerted by the user. The weight buffer 3 will retard the motion of the main body 1 of the input device with its inertia as if a resisting force were applied to the main body 1. Thus, the impact force which possibly impacts the user's wrist when moving the main body 1 is alleviated by the retarding effect of the weight buffer 3 and the user does not need to exert a large effort to stop the main body 1 at a predetermined position or when a sudden change of moving direction is required, thereby successfully preventing injury to the user's wrist. In these embodiments, the elastic buffer 4 plays an important roll as an absorbent to the impact energy of the weight buffer 3 arriving at the terminal of the slide track 2 so as to protect the slide track 2 from being damaged. As described above, all the slide tracks 2 are disposed in a way such that their longitudinal axes along the main body 1 of the input device are in parallel, perpendicular, or even intersected at an arbitrary angle with each other so as to allow the main body 1 of the input device to move freely in any desired direction.

Although the description above contains many examples, these should not be construed as limiting the scope of the invention but as merely providing illustration of some of the presently preferred embodiments of this invention. Thus the scope of the invention should be determined by the appended claims and their legal equivalents, rather than by the examples given.

What is claimed is:

1. A track type impact buffered input device comprising:
a main body of said input device;
at least one slide track provided in said main body; and
at least one weight buffer installed in each of said at least one slide track.

2. The input device of claim 1, wherein each of said at least one slide track is a closed loop type track.

3. The input device of claim 2, wherein said slide track is a loop track.

4. The input device of claim 2, wherein said closed loop type track is a rectangular track.

5. The input device of claim 2, wherein said closed loop type track is an elliptic track.

6. The input device of claim 2, wherein said closed loop type track is a polygonal track.

7. The input device of claim 1, wherein said slide tracks are disposed longitudinally in parallel to each other along the advancing direction.

8. The input device of claim 1, wherein said slide tracks are disposed longitudinally perpendicular to each other along the advancing direction.

9. The input device of claim 1, wherein said slide tracks are disposed with their longitudinal axes along the advancing direction intersected with each other at an arbitrary angle.

10. The input device of claim 1, wherein each of said at least one slide track is a long elongated track.

11. The input device of claim 10, wherein said long elongated tracks are disposed longitudinally in parallel to each other along the advancing direction.

12. The input device of claim 10, wherein said long elongated tracks are disposed longitudinally perpendicular to each other along the advancing direction.

13. The input device of claim 10, wherein said long elongated tracks are disposed with their longitudinal axes along the advancing direction intersected with each other at an arbitrary angle.

14. The input device of claim 10, wherein an elastic buffer is installed at each of two ends of each of said at least one slide track.

15. The input device of claim 14, wherein said elastic buffer is made of rubber, cotton, foam cotton, or thermoplastic elastomer.

16. The input device of claim 14, wherein said elastic buffer is a spring.

17. The input device of claim 1, wherein said weight buffer is made of a high massive substance.

18. The input device of claim 17, wherein said weight buffer is a weight.

19. The input device of claim 17, wherein said weight buffer is a lead bead.

20. The input device of claim 17, wherein said weight buffer is a gravity ball.
